(19) United States
(12) Patent Application Publication
(10) Pub. No.: US 2014/0048699 A1
(43) Pub. Date: Feb. 20, 2014

(54) METHOD AND SYSTEM FOR SIMULTANEOUSLY FINDING AND MEASURING MULTIPLE ANALYTES FROM COMPLEX SAMPLES

(71) Applicant: University of Washington through its Center for Commercialization, (US)

(72) Inventors: Buddy D. Ratner, Seattle, WA (US); Edward Lo, Seattle, WA (US); Christopher Barnes, Seattle, WA (US); M. Jeanette Stein, Bothell, WA (US)

(73) Assignee: University of Washington through its Center for Commercialization, Seattle, WA (US)

(21) Appl. No.: 13/870,577

(22) Filed: Apr. 25, 2013

Related U.S. Application Data
(63) Continuation of application No. PCT/US2011/057706, filed on Oct. 25, 2011.
(60) Provisional application No. 61/406,559, filed on Oct. 25, 2010.

(51) Int. Cl. H01J 49/26; H01J 49/10

(52) U.S. Cl. CPC H01J 49/26; H01J 49/10
USPC 250/282; 250/288

(57) ABSTRACT

Method and system for detecting multiple analytes from a sample material by desorption ionization, mass analysis, and multivariate statistical analysis.

### CROSS-REFERENCE TO RELATED APPLICATION

This application is a continuation of International Application No. PCT/US2011/057706, filed Oct. 25, 2011, which claims the benefit of U.S. Provisional Patent Application No. 61/406,559, filed Oct. 25, 2010, each expressly incorporated herein by reference in its entirety.

### BACKGROUND OF THE INVENTION

Micronutrient deficiencies persist as one of the major contributors to the global burden of disease. For this reason, interest in the measurement of certain key micronutrients in humans and food is intensifying. Conventional serum micronutrient concentration measurements are slow, complex and the cost for materials can run between $5-10/measurement (cost of ELISA kits or auto-analyzer methods) making them cost-prohibitive for large studies of multiple analytes. Rapid, efficient micronutrient detection technology demands rapid sampling time, high sensitivity, analytical accuracy, and instrument portability. A device possessing all of these features could have a dramatic impact on global health by facilitating population-wide nutritional studies. However, there is currently no one technology that fulfills all of these requirements.

Mass spectrometry (MS) and MS-based methods are recognized as being among the most sensitive general purpose analytical methods with multiple features advantageous for the rapid and specific trace identification of specific organic chemical compounds. MS methods are selective, broadly applicable, and provide high specificity. However, only since the recent development of ambient MS ionization methods could MS methods be applied without significant sample manipulation, which had previously limited the MS techniques to the laboratory environment. Since the introduction of direct ambient ionization, more than a dozen different ambient desorption ionization methodologies have been applied to a wide variety of compounds such as peptides, proteins, explosives, and pharmaceuticals. Among the direct ambient ionization methods, plasma pencil atmospheric mass spectrometry (PPAMS) is a technique that employs a low-temperature plasma probe (LTP-probe) for desorbing and ionizing species of interest from liquid or solid samples.

Despite the advancement of analytical techniques noted above, a need exists for a robust, field deployable system and method that provides for the rapid, simultaneous detection of the multiple components in complex matrices that are conventionally difficult to analyze. The present invention seeks to fulfill this need and provides further related advantages.

### SUMMARY OF THE INVENTION

The present invention provides a method and system for detection of multiple analytes from complex samples.

In one aspect, the invention provides a method for detecting analytes in a sample material. In one embodiment, the method comprises:

(a) generating analyte particles by ambient desorptive ionization of a sample material;

(b) analyzing the analyte particles with a mass analyzer to provide a mass spectrum of the analyte particles from a mixed sample; and

(c) determining the presence of the analytes in the sample material by multivariate statistical analysis of the mass spectrum.

In one embodiment, generating analyte particles by ambient desorption ionization comprises contacting the sample material with a plasma (e.g., a low temperature plasma). In another embodiment, generating analyte particles by ambient desorption ionization comprises contacting the sample material with a desorption electrospray ionization source.

In one embodiment, the analyte particle is a positive ion. In another embodiment, the analyte particle is a negative ion.

In one embodiment, the mass analyzer is an atmospheric mass analyzer (e.g., mass spectrometer or ion mobility spectrometer). Suitable mass analyzers include ion trap mass spectrometers, quadrupole mass spectrometers, and ion cyclotron mass spectrometers.

In one embodiment, the multivariate statistical analysis comprises principal components analysis. In another embodiment, the multivariate statistical analysis comprises partial least-squares regression analysis.

In another aspect of the invention, a system for detecting analytes in a sample material is provided. In one embodiment, the method comprises:

(a) an ambient desorptive ionization source for generating analyte particles;

(b) a mass analyzer for analyzing the analyte particles to provide a mass spectrum of the particles; and

(c) a multivariate statistical analysis program for analyzing the mass spectrum to determine the presence of the analytes in the sample material.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 is a schematic illustration of a representative system of the invention including an ambient desorption ionization source, mass analyzer, and associated multivariate statistical analysis package.

FIG. 2A is a scores plot from principal components analysis (PCA) of the positive ion spectra comparing peaks from a bovine serum albumin (BSA) solution sample, a BSA solution sample doped with high blood level (HBL) iron (Fe) sample and a sample containing all five nutrients at HBL. Principal component (PC) 1 captures 80% of the variance in the samples and represents the addition of Fe into the solutions.

FIG. 2B is a loadings plot for PC1 clearly shows that peaks typically linked to iron are present in the positive PC loadings. Characteristic iron peaks show at m/z 55 (Fe⁺), and 112 (Fe₂) verifying that the addition of iron is responsible for PC1. Peaks at 43, 44, and 59 are ions that display improved ionization upon the addition of iron into the system.

FIGS. 3A-3F are positive ion electrospray ionization mass spectrometry (ESI-MS) data of mixed micronutrient samples prepared in methanol obtained on the same mass spectrometer used in PPAMS. Solutions are multicomponent mixtures consisting of one nutrient at a 10-fold concentration of its HBL concentration and the remaining four nutrients at a 1×HBL concentration (4 NutrHBL). ESI-MS product ion mode spectra of the M+ protons of the mixtures are shown. Changes in each spectrum versus the control 5 NutrHBL spectrum (FIG. 3F) were assumed to be due to the presence of the excess nutrient. The major ions believed to be from the fragmentation of each nutrient are labeled: FIG. 3A shows the majority of thyroxine's (Thyr) major fragments are a higher molecular weight, only m/z 271 (C₆H₅O₂ICl⁺) is visible in the 80-300 range shown; FIG. 3B shows m/z 101 (ZnCl⁺+H₂), 133 (ZnCl⁺+O₂+H₂), 143 (ZnCl⁺+C₂H₂O+H₂), 172 (ZnCl₂⁺+HCl+H₂), 228 (ZnCl₂+FeCl⁺+H₂), 268 (2ZnCl₂) and 291 (2ZnCl₂+H₂O+H₂+H⁺) were attributed to zinc (Zn); FIG. 3C shows m/z 91 (FeCr), 109 (FeCl⁺+H₂O), 228 (ZnCl₂+FeCl⁺+H₂), and 289 (2FeCl₂+2H₂O+H⁺) represented iron (Fe); FIG. 3D shows m/z 165 (C₁₁H₁₇O⁺), 181 (C₁₁H₁₇O₂⁺), 251 (C₁₅H₂₃O⁺+O₂), 269 (C₁₅H₂₃O⁺+O₂+H₂O), and 291 (C₁₈H₂₇O₃⁺) indicated retinol (Ret); and FIG. 3E shows m/z 177 (C₇H₇N₅O⁺), 193 (C₇H₉N₆O⁺), 253 (C₁₂H₁₃N₁O₅⁺), and 290 (C₁₃H₁₁N₆O₂+Na⁺) represented folic acid (FA). ESI-MS/MS product ion data confirmed the identification of the labeled peaks (data not shown).

FIGS. 4A and 4B present the PCA results for the ESI-MS positive ion spectra shown in FIGS. 3A-3E. These are presented as scores (FIG. 4A) and loadings (FIG. 4B) plots. The scores plot displays an excellent separation of each of the micronutrients present in the HBL mixed solutions. Ellipses drawn around each of the groups represent the 95% confidence limit for that group on PCs 1 and 2. The loadings associated with PC 1, capturing 75% of the system variance, show how the original ESI-MS peaks relate to the location of the spectra on the scores plot. Symbols indicate the nutrient associated with a given peak as determined through a plot of the raw nutrient mass peaks at each mass number. In comparing FIGS. 4A and 4B, more contributing peaks for Zn and Fe in the positive loadings can be seen, with more Thyr, and FA in the negative loadings. There is a loose correlation with an increase in the HBL concentration of the nutrient and an increase in loading value. Symbols: () 5 NutrHBL; (∇) 4 NutrHBL+10×FA; (*) 4 NutrHBL+10× Ret; (⋄) 4 NutrHBL+10× Fe; ( [symbol] ) 4 NutrHBL+10× Zn; and ( [symbol] ) 4 NutrHBL+10× Thyr (n=3).

FIGS. 5A-5F are raw positive ion PPAMS data acquired by a representative system of the invention. FIG. 5A shows raw positive ion PPAMS data of a mixed micronutrient sample of all five micronutrients at HBL concentration in methanol spotted and dried on a glass disk. While numerous MS/MS spectra were taken on each sample, a single characteristic peak and accompanying PPAMS/MS has been included for each micronutrient. The PPAMS/MS product ion positive-ion mode spectra taken on raw single nutrient powders fixed on double stick tape included: MS/MS of m/z 119 (ZnCl⁺+H₂+H₂O) (FIG. 5B); MS/MS of m/z 129 (CHNFe+N₂+H₂O) (FIG. 5C); MS/MS of m/z 287 Ret (M+H⁺) (FIG. 5D); MS/MS of m/z 389, a fragment from FA (C₁₂H₁₃N₂O₅+O₂+2N₂+2H₂O) (FIG. 5E); and MS/MS of m/z 363 a single ring from Thyr (C₆H₅I₂O₂) (FIG. 5F).

FIG. 6A is a scores plot from PCA of the PPAMS positive ion spectra of a set of solutions modeling a relatively “healthy” individual in which four of the nutrients are at HBL concentrations and only one is at LBL concentrations as indicated. Symbols: (−) 5 NutrLBL; (o) 4 NutrHBL+FALBL; (*) 4 NutrHBL+RetLBL; (X) 4 NutrHBL+FeLBL; (∇) 4 NutrHBL+ZnLBL; and (+) 4 NutrHBL+ThyrLBL.

FIG. 6B is a loadings plot for PC 1 (41%) from PCA of positive ion spectra for the “healthy” blood model. Peaks of interest have been labeled and the nutrient(s) associated with them were determined through plots of the raw spectra for each mass.

FIG. 6C is a scores plot from the positive ion spectra of the inverse set of samples modeling a relatively “unhealthy” individual in which four of the nutrients are at LBL concentrations and only one is at HBL concentration as indicated. Symbols: (−) 5 NutrHBL; (o) 4 NutrLBL+FAHBL; (*) 4 NutrLBL+RetHBL; (X) 4 NutrLBL+FeHBL; (∇) 4 NutrLBL+ZnHBL; and (+) 4 NutrLBL+ThyrHBL.

FIG. 6D is a loadings plot for PC 1 (46%) for the “unhealthy” blood model. All solutions were formed in a 10% porcine plasma solution in isotonic citrate-phosphate buffered saline (cPBSz) containing sodium azide.

FIG. 7 shows the PCA results for pure water (slightly acidic) versus low contamination water doped with lead, copper, and zinc at low levels and high contamination water doped with the three analytes set at high concentrations. The results yield excellent separation of the data as evidenced by the 95% confidence ellipses surrounding the data samples.

FIGS. 8A-8C show the PCA results for pure water (slightly acidic) versus low contamination water doped with lead, copper, and zinc at low level compared to and water in which the contamination of only one analyte lead (FIG. 8A), copper

(FIG. 8B), or zinc (FIG. 8C), respectively, was increased individually to a high concentration.

FIG. 9A-9C show the PCA results for PVC samples containing lead and BPA contaminants. Analysis of 5 sample groups with varying analyte concentrations gave clear separation between all sample types on a PC 1 versus PC 3 plot (FIG. 9A). This separation is highlighted when the concentration of only one analyte is varied (lead and BPA in FIGS. 9B and 9C, respectively) and compared to a low concentration contaminant sample and pure PVC.

### DETAILED DESCRIPTION OF THE INVENTION

The present invention provides a method and system for detecting analytes in complex matrices. Analytes are detected from a sample material by obtaining a single mass spectrum from a sample that contains multiple analytes and then identifying individual analytes from that spectrum by multivariate statistical analysis. Through the use the multivariate statistical analysis, based on chemometrics and pattern recognition, the method and system readily identify individual analytes from complex matrices.

In one aspect, the invention provides a method for detection of analytes in a sample material. In one embodiment, the method includes:

(a) generating analyte particles by ambient desorptive ionization of a sample material;

(b) analyzing the analyte particles with a mass analyzer to provide a mass spectrum of a mixed analyte sample; and

(c) determining the presence of the analytes in sample materials by multivariate statistical analysis on their mass spectra.

As used herein, the term “analyte particles” refers to neutral molecules and molecule fragments, negatively charged ions, and positively charged ions generated by interaction of a desorptive ionization source with the sample material. In one embodiment, the detected analyte particle is a positive ion. In another embodiment, the detected analyte particle is a negative ion.

The term “desorptive ionization” refers to ionization that results in the desorption of analyte particles (e.g., neutral, negative, and positive) from the sample material. The term “ambient desorptive ionization” refers to desorptive ionization that occurs under ambient conditions (e.g., atmospheric pressure).

Suitable desorption ionization sources include those known in the art. Representative desorptive ionization sources useful in the method and system of the invention include desorption electrospray ionization (DESI) sources, desorption sonic spray ionization (DeSSI) sources, desorption atmospheric pressure photoionization (DAPPI) sources, direct analysis in real time (DART) sources, atmospheric solids analysis probe (ASAP) sources, desorption atmospheric pressure chemical ionization (DAPCI) sources, dielectric barrier discharge ionization (DBDI) sources, plasma-assisted desorption/ionization (PADI) sources, neutral desorption sampling extractive electrospray ionization (ND-EESI) sources, electrospray-assisted laser desorption ionization (ELDI) sources, laser ablation-electrospray ionization (LAESI) sources, matrix-assisted laser desorption electrospray ionization (MALDESI) sources, infrared laser-assisted desorption electrospray ionization (IR-LADESI) sources, and plasmas including low temperature plasmas (LTP).

A representative low temperature plasma probe useful in the method and system of the invention is described in US 2011/004560, incorporated herein by reference in its entirety. A suitable plasma pencil is commercially available from PVA TePLA America (Corona, Calif.).

In one embodiment, generating analyte particles by desorption ionization comprises contacting the sample material with a plasma. In one embodiment, the plasma is a low temperature plasma.

In other embodiments, generating analyte particles by desorption ionization comprises contacting the sample material with is a desorption electrospray ionization source, a paper spray ionization source, a desorption sonic spray ionization source, a desorption atmospheric pressure photoionization source, a direct analysis in real time source, an atmospheric solids analysis probe source, a desorption atmospheric pressure chemical ionization source, a dielectric barrier discharge ionization source, a plasma-assisted desorption/ionization source, a neutral desorption sampling extractive electrospray ionization source, an electrospray-assisted laser desorption ionization source, a laser ablation-electrospray ionization source, a matrix-assisted laser desorption electrospray ionization source, or a infrared laser-assisted desorption electrospray ionization source.

In the method and system of the invention, the analyte particles are analyzed with a mass analyzer to provide a mass spectrum of the analyte particles. The mass spectrum is a collection of peaks from analyte particles desorbed from a single sample. In the method and system of the invention, individual mass spectra of component analyte particles are not measured. This is in contrast to conventional atmospheric mass spectrometric techniques that rely on separating the components of a sample (e.g., a chromatographic method such as gas or liquid chromatography, or a tandem MS method) followed by measuring the mass spectra of each separated component. In the method and system of the invention, the analysis is performed on a single mass spectrum of the desorbed analyte particles.

Suitable mass analyzers include those known in the art. In one embodiment, the mass analyzer is a mass spectrometer. Suitable mass spectrometers include ion trap mass spectrometers, quadrupole mass spectrometers, and ion cyclotron mass spectrometers. In another embodiment, the mass analyzer is an ion mobility spectrometer. In the system and method of the invention, the mass analyzers are atmospheric mass analyzers. As used herein, the term “atmospheric mass analyzer” refers to a mass analyzer that operates at atmospheric pressure. This is in contrast to conventional mass analyzers, which operate at extremely low pressure.

As noted above, the method and system of the invention are effective in determining the presence of the analytes in a sample material by chemometric (pattern recognition) analysis of the mass spectrum. The chemometric analysis is a multivariate statistical analysis. In one embodiment, the multivariate statistical analysis comprises principal components analysis (PCA). In another embodiment, the multivariate statistical analysis comprises partial least-squares (PLS) regression analysis.

The nature of the sample material analyzed by the method and system of the invention is not critical. The method and system of the invention are effective in analyzing solids and liquids. Suitable solids include amorphous and crystalline solids, and monolithic and powdered solids. Suitable liquids include aqueous and organic liquids and gels.

Representative sample materials include plastics, polymers, fabrics, textiles, metals, ceramics, or mixtures thereof. In one embodiment, the sample material is a surface coating.

Representative sample materials include biological materials such as whole blood, blood plasma, saliva, mucus, urine, skin, hair, tissue, or mixtures thereof.

In one embodiment, the sample material is a food or drink. In certain embodiments, the sample material is a chemical agent. Representative chemical agents include pharmaceutical agents and explosives.

In another aspect, the invention provides a system for detection of analytes. In one embodiment, the system includes:

(a) a desorptive ionization source for generating analyte particles;

(b) a mass analyzer for analyzing the analyte particles on a mixed analyte surface to provide a mass spectrum of the particles; and

(c) a multivariate statistical analysis program for analyzing resulting mass spectra to determine the presence of the analytes in the sample materials.

Suitable desorptive ionization sources include those described above including ambient desorption ionization sources. In one embodiment, the desorptive ionization source is a plasma. In one embodiment, the desorption ionization source is a low temperature plasma. In one embodiment, the desorption ionization source is a desorption electrospray ionization source.

Suitable mass analyzers sources include those described above including atmospheric mass analyzers. In one embodiment, the mass analyzer is an atmospheric mass spectrometer.

Suitable multivariate statistical analysis programs include those described above.

In one embodiment, the multivariate statistical analysis program comprises a principal components analysis program. Principal components analysis is described in Wagner, M. S., and Castner, D. G. Langmuir 2001, 17, 4649-4660, expressly incorporated herein by reference in its entirety. In one embodiment, the multivariate statistical analysis program comprises partial least-squares regression analysis program.

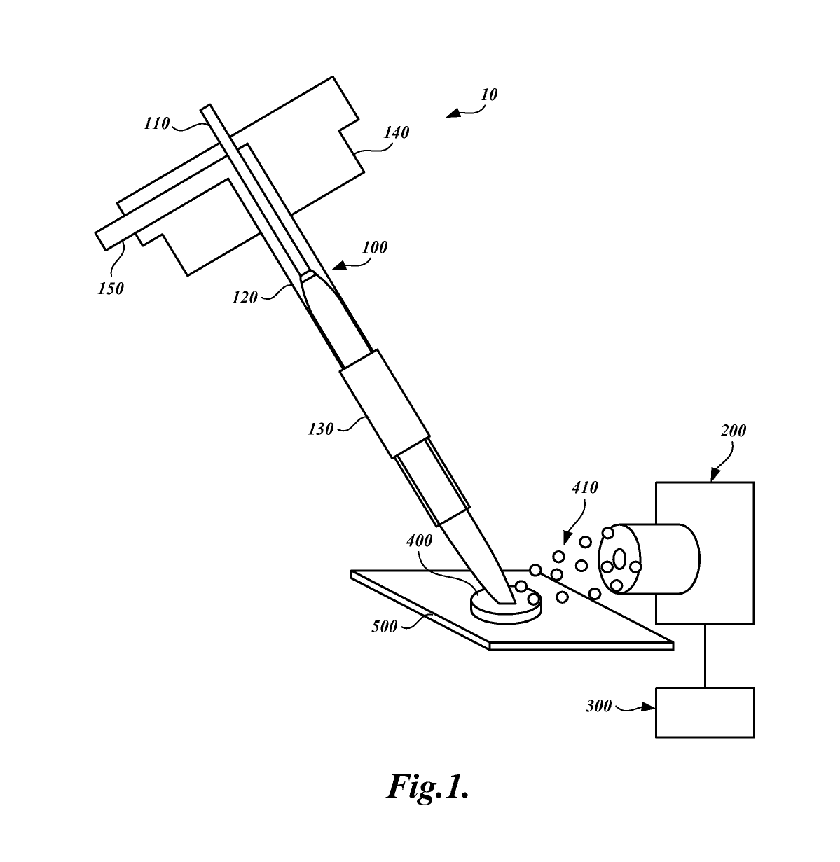

A representative system of the invention is illustrated schematically in FIG. 1. Referring to FIG. 1, system 10 includes desorption ionization source (plasma pencil) 100, mass analyzer 200, and associated multivariate statistical analysis program 300. The representative plasma pencil ionization source includes high voltage electrode 110, dielectric barrier 120, high voltage return 130, and optionally mount 140 for positioning and holding the pencil. Discharge gas is introduced into the pencil through input 150 to provide a low temperature plasma effective to generate analyte particles 410 (e.g., positive and negative ions and neutrals) from sample 400 supported by substrate 500. In the method of the invention, desorbed analyte particles generated by the plasma's interaction with the sample are introduced to the mass analyzer, which provides a mass spectrum that is analyzed by multivariate statistical analysis.

PPAMS Analysis of Nutrient Powder

The following is a description of a representative method and system of the invention for the simultaneous in situ detection of multiple analytes (i.e., vitamin A in the form of retinol, iron, zinc, folate, and iodine bound in thyroxine) in a powder nutrient form. The experimental details are described in Example 1.

The analyzed micronutrients along with their structures and molecular weights are listed in Table 1.

TABLE 1
Micronutrients, their structures and molecular weights.

| Compound | Structure | MW |
|---|---|---|
| Iron | FeCl₂ | 127 |
| Zinc | ZnCl₂ | 136 |
| Folate: Folic Acid | 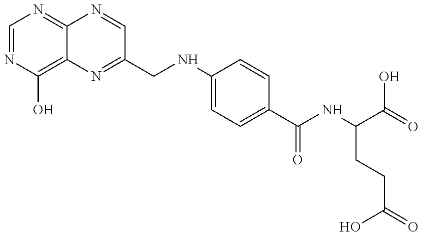 [SMILES: O=C(O)CCC(NC(=O)c1ccc(NCc2cnc3ncnc(O)c3n2)cc1)C(=O)O] | 426 |
| Vitamin A: Retinol | 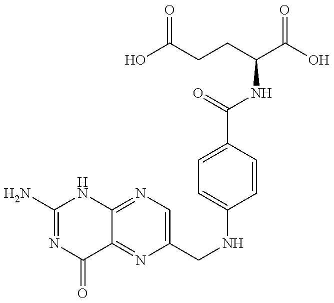 [SMILES: Nc1nc(=O)c2nc(CNc3ccc(C(=O)N[C@@H](CCC(=O)O)C(=O)O)cc3)cnc2[nH]1] | 441 |
| Iodine: Thyroxine | 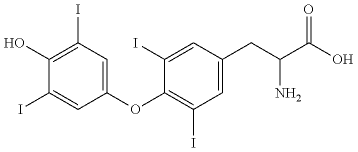 [SMILES: NC(Cc1cc(I)c(Oc2cc(I)c(O)c(I)c2)c(I)c1)C(=O)O] | 777 |

In the system of the invention, the PPAMS LTP-probe was coupled to an ion trap mass spectrometer and its sensitivity and specificity was assessed for each of the micronutrients individually, as well as in a physiologically-based model for blood plasma. Key ion fragments were obtained on neat micronutrient powders that aided in the characterization of the nutrients in methanol, bovine serum albumin (BSA), and porcine blood plasma matrices. The ion fragments obtained were in excellent agreement with corroborating experiments conducted with time-of-flight secondary ion mass spectrometry (ToF-SIMS) and electrospray ionization mass spectrometry (ESI-MS) experiments. Furthermore, PPAMS data were obtained on porcine blood plasma solutions in which micronutrients were doped to levels modeling artificially healthy and unhealthy individuals. Experiments aimed at identifying and separating out the individual micronutrients were conducted through the use of the multivariate statistical modeling method, principal components analysis (PCA), on the spectra resulting from the physiological models.

Time-of-Flight Secondary Ion Mass Spectrometry with Principal Component Analysis of Spectral Features of Micronutrients.

To establish that the PPAMS system was effective to detect micronutrients at appropriate physiological concentrations, standard mixtures of the five micronutrients of interest were prepared and analyzed using ToF-SIMS. A sample preparation protocol was developed for these corroborative experiments with standard concentrations of the micronutrients dissolved in a 1 mg/ml bovine serum albumin (BSA) in dH₂O solution. The standard concentrations were based on adding 100% of the recommended daily allowance (RDA) of each nutrient in 1 cup of protein solution to simulate nutrient detection in a food source. The final RDA concentrations used were 1.7 ppm folic acid (FA), 3.8 ppm vitamin A in the form of retinol (Ret), 625 ppb iodine in the form of thyroxine (Thyr), 75 ppm iron (Fe), and 46 ppm zinc (Zn). A secondary preparation protocol was developed based off of the concentrations of nutrients expected in the blood of an adult human. These samples were based on the high blood level concentrations (HBLCs) expected in human blood and were also prepared in a 1 mg/ml BSA/dH₂O solution. The final HBLCs used were 50 ppb FA, 650 ppb Ret, 105 ppb Thyr, 2 ppm Fe and 20 ppm Zn. A 10 μL droplet of each solution was pipetted onto a 12 mm diameter, clean glass coverslip and allowed to dry overnight in a vacuum desiccator prior to analysis.

ToF-SIMS experiments were performed in both positive- and negative-ion modes. As noted in the examples section, positive ion results are described herein. ToF-SIMS is a highly sensitive surface analysis technique yielding information about the chemistry of the outermost 1-2 nm of a sample. Each spectrum contains hundreds to thousands of peaks often challenging the ability to visually discern trends in the data. To facilitate data analysis, mathematical algorithms such as PCA are commonly applied to visualize and identify groupings of peaks responsible for the greatest variance between samples. The PCA algorithm leads to two primary matrices referred to as scores and loadings. For a description of scores and loadings, see Wagner, M. S.; Graham, D. J.; Ratner, B. D.; Castner, D. G. Surf Sci. 2004, 570, 78-97, expressly incorporated herein by reference in its entirety.

The scores plots show relationships between samples in the new axis system, and the loadings plots relate the original variables (i.e., m/z peaks in the case of ToF-SIMS) to the new variables (i.e., axes) named principal components (PCs).

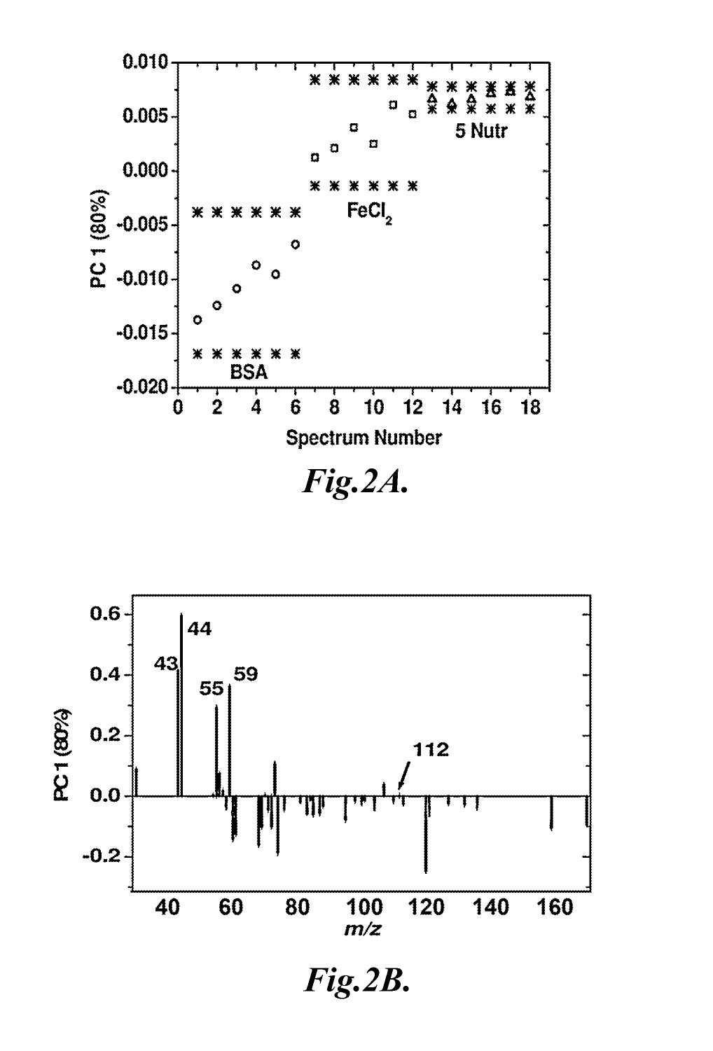

All of the nutrients were found to be detectable from the BSA solution over a certain concentration range. The metal ion nutrients (Fe and Zn) were readily detectable at the listed HBLCs and could be easily separated from the BSA controls using PCA. Representative ToF-SIMS positive ion scores and loadings plots from iron are shown in FIGS. 2A and 2B. As the data sets used in PCA are made up of several different types of samples, statistical limits were employed to differentiate the sample types. The scores were assumed to follow a normal distribution as the sample groups consist of replicate spectra from the same sample type. At distribution was utilized to calculate 95% confidence ellipses and confidence intervals about each data group's PC scores. For a description of PC scores, see Wagner, M. S.; Castner, D. G. Langmuir 2001, 17, 4649-4660, and Wise, B. M.; Gallagher, N. B. PLS_{—}Toolbox Version 2.0 Manual; Eigenvector Research: Manson, Wash., 1998, each expressly incorporated herein by reference in its entirety. Scores and loadings plots of PC 1 (capturing 80% of the total variance between the samples) comparing three samples, a plain BSA sample, a sample doped with iron, and a sample doped with all five nutrients, are shown in FIGS. 2A and 2B. These plots show that the primary difference between the three sample groups is the addition of iron into the BSA solution. Common fragments for this nutrient dominated the loadings plots; in particular, peaks such as FeH⁺ (m/z 55), and Fe₂⁺ (m/z 112) were shown to influence the scores plots. Inspection of PC 1 plots for samples comparing zinc also showed separation which could be correlated well to the addition of that nutrient. Specifically, the Zn⁺ and ZnH⁺ ions were important for separation. For both these metals, various isotopes were detectable and used to clarify differences between samples thus enhancing the separations of PCs.

The remaining three nutrients were not found to separate as easily from the controls at the concentrations necessary for blood analysis at a 1× concentration. Ret was found to separate at RDA values (about 5×HBL), with the majority of its many peaks arising from different fragmentations of its hydrocarbon tail. These peaks were confirmed to be indicative of Ret by analyzing different concentrations of solutions (10× and 20×HBLCs) and searching for peaks which reflected these concentration differences (i.e., peaks that became more prominent as the concentration of Ret was increased). This was necessary because the chemical structure of Ret combined with the ubiquity of hydrocarbons found in biological materials and the atmosphere minimized the uniqueness of peaks arising from Ret's structure. Both Thyr (an iodine-binding molecule found in blood) and FA were only discernible when analyzed at 1000×HBLC. At these high concentrations, both the molecular ions were detected in addition to several characteristic fragment peaks that were identified. Thyr peaks identified included the molecular ion (m/z 777), several fragment peaks (m/z 732, 577, 449 and 359), as well as a highly prominent iodine related peak (m/z 172.8, identified as NaINa⁺). FA peaks identified included the molecular ion (m/z 441), some prominent fragment peaks (m/z 176, 177, 178), as well as two less prominent peaks (m/z 295 and 296) were detected.

ESI-MS and PCA Analysis of HBLC Nutrients.

Nutrient fragmentation was characterized by mass spectrometry (Bruker-Esquire LC-ion trap mass spectrometer) and verified that the HBLCs were within the detection limits for the spectrometer. Mixed solutions of nutrients were prepared at 1×HBLC for four nutrients and at 10×HBLC for the remaining nutrient in methanol for each of the five nutrient types. Similar to the ToF-SIMS samples, the final HBLCs used were 50 ppb FA, 650 ppb Ret, 105 ppb Thyr, 2 ppm Fe and 20 ppm Zn. Samples were infused by flow injection at 1.5 μL/min and analyzed via ESI-MS. The mixed nutrient mass spectra were then cross-compared to a control solution spectrum taken on a solution of all five nutrients at HBLCs. Unlike ToF-SIMS and PPAMS, methanol was chosen over a BSA or porcine plasma solution for the dilutions due to the signal saturation caused by high salt content in BSA or plasma (data not shown).

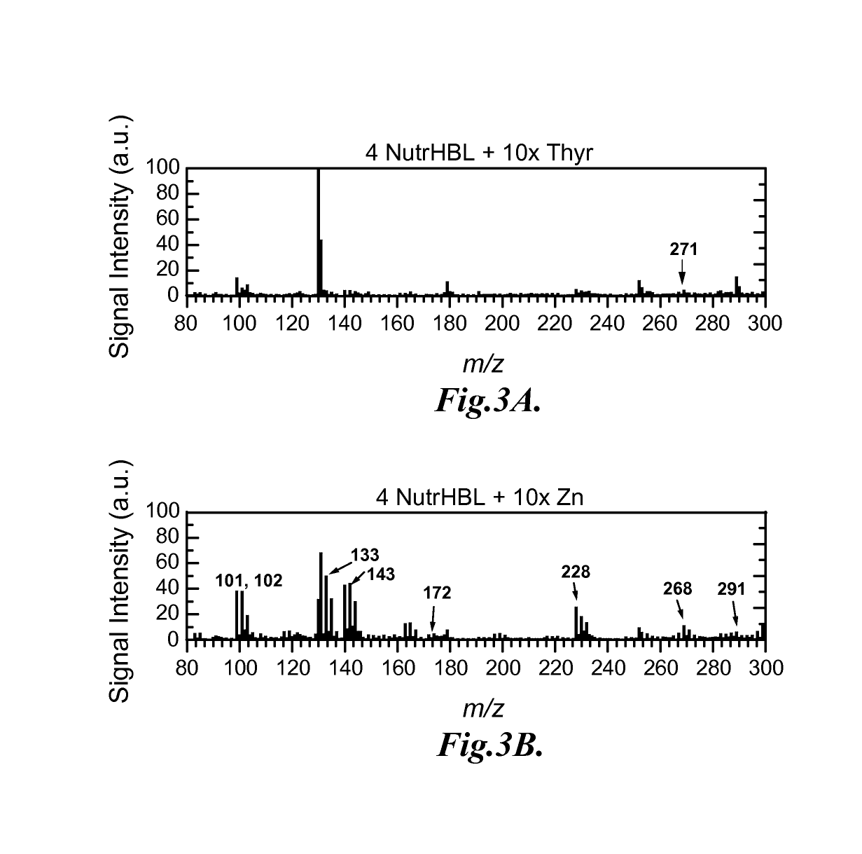

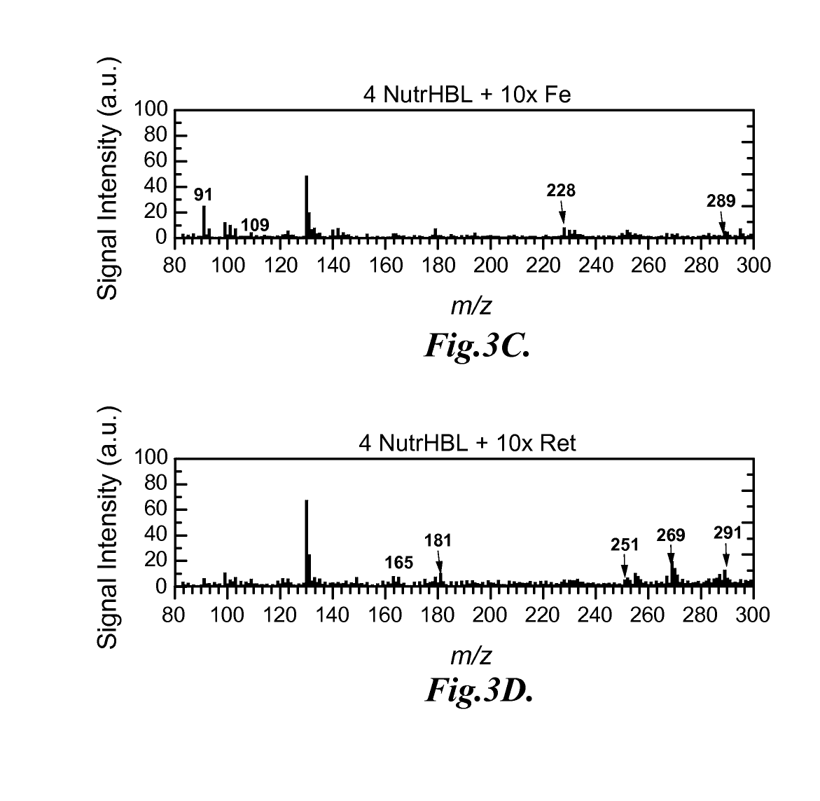

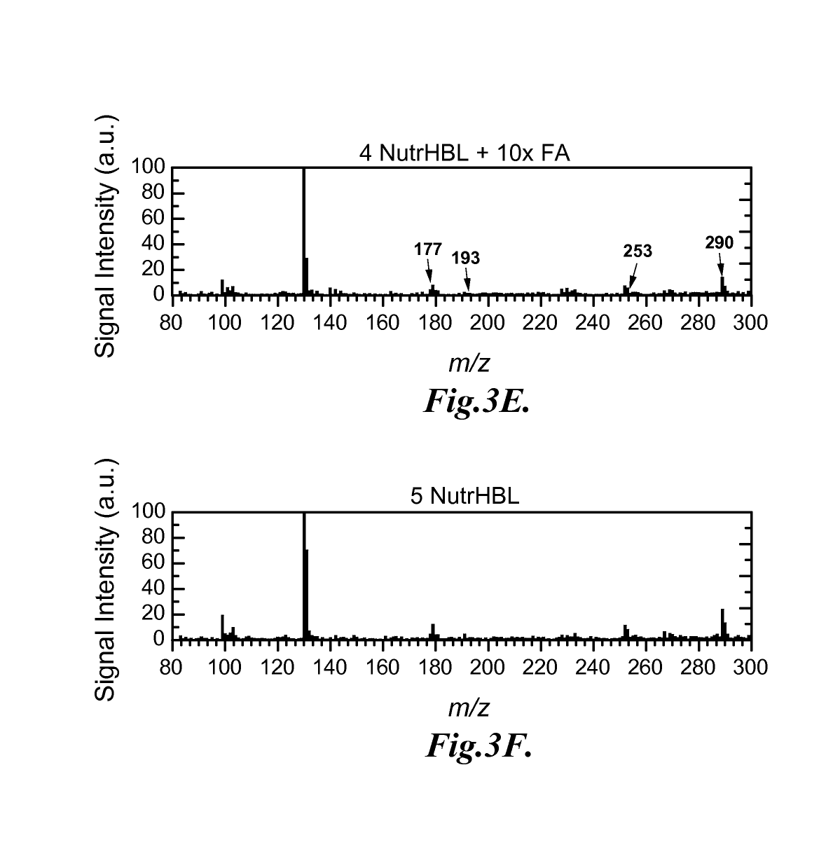

FIGS. 3A-3F show the positive-ion ESI-MS spectra of the mixed micronutrient samples prepared in methanol. Most of the peaks are present in all spectra. Certain peaks show an increase in intensity in the spectra in which an excess of a single micronutrient is added (FIGS. 3A-3E). PCA was run for each individual spectra (FIGS. 3A-3E) versus the control spectra FIG. 3F to obtain the nutrient ion peaks responsible for differentiating the peaks from the control group. A few representative peaks are clearly visible and have been labeled in these FIGUREs. The identities of each of the labeled peaks (see description of FIGS. 3A-3F above) were confirmed through MS/MS spectra taken during subsequent scans (data not shown). The complexity and number of peaks present in these spectra complicate the analysis of nutrient concentration. The process was more challenging upon the addition of protein and salt solutions. Multivariate techniques assist in performing the analysis by reducing multiple variables to a single variable best expressing the greatest degree of variance.

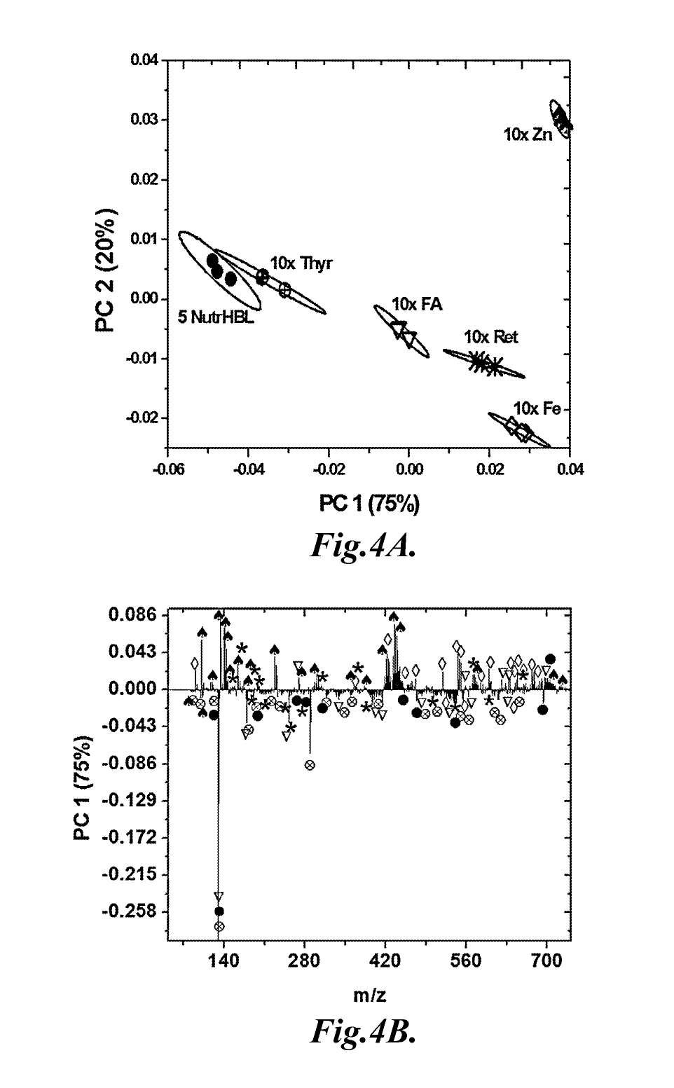

PCA of the positive ion ESI-MS data from FIGS. 3A-3F readily distinguishes between the solutions with the excess micronutrient. The scores plot for the first two PCs is shown in FIG. 4A. The first two PCs account for 95% of the total variance in the data set. PC 1, which captures 70% of the variance, displays a loose positive correlation with an increase in the sum of the concentrations of the added nutrients (i.e., separation in PC 1 is seen to develop from an increase in the total nutrient content in the sample). The corresponding loadings plot for PC 1 is shown in FIG. 4B. Each loading peak is marked by colored dots that indicate the peak's contributing nutrients (Symbols: () 5 NutrHBL; (∇) 4 NutrHBL+10×FA; (*) 4 NutrHBL+10× Ret; (⋄) 4 NutrHBL+10× Fe; ( [symbol] ) 4 NutrHBL+10× Zn; and ( [symbol] ) 4 NutrHBL+10× Thyr (n=3)). Visually, the addition of excess Zn (the micronutrient with the highest HBLC) appears to account for the separation demonstrated in PC 2. This trend continues with excess Fe correlating to the separation in PC 3. Additional PCs were also seen to separate the nutrients with lower blood concentrations. It is noted that while this correlation appears to be strong for this particular PCA plot, the PCA scores represent a multivariate combination of several peaks that are up and down regulated depending on fragmentation patterns. With the addition of a physiological buffer solution and proteins the scores may not yield as linear a correlation between the abundance of the individual micronutrients.

Plasma Pencil Atmospheric Mass Spectrometry (PPAMS).

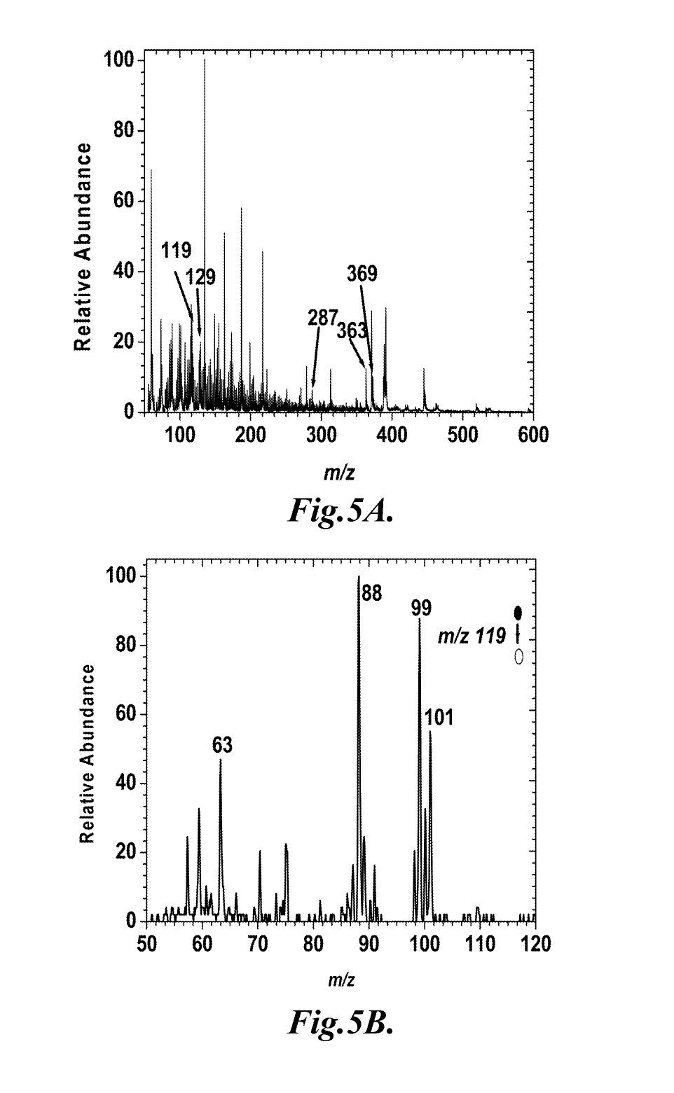

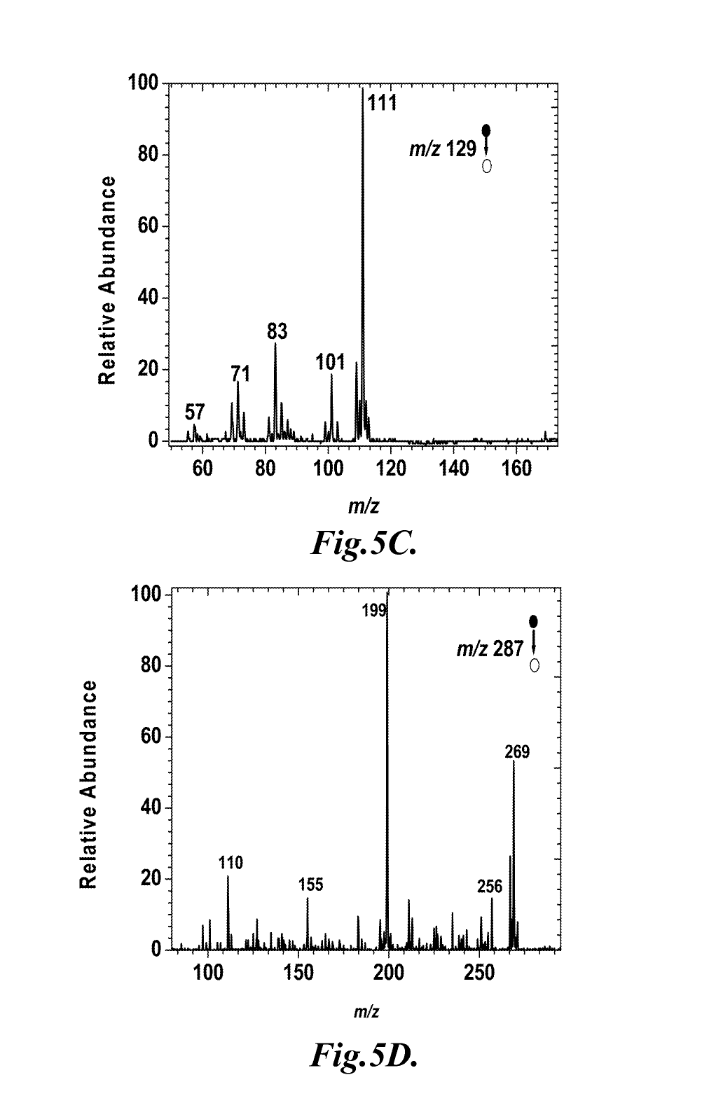

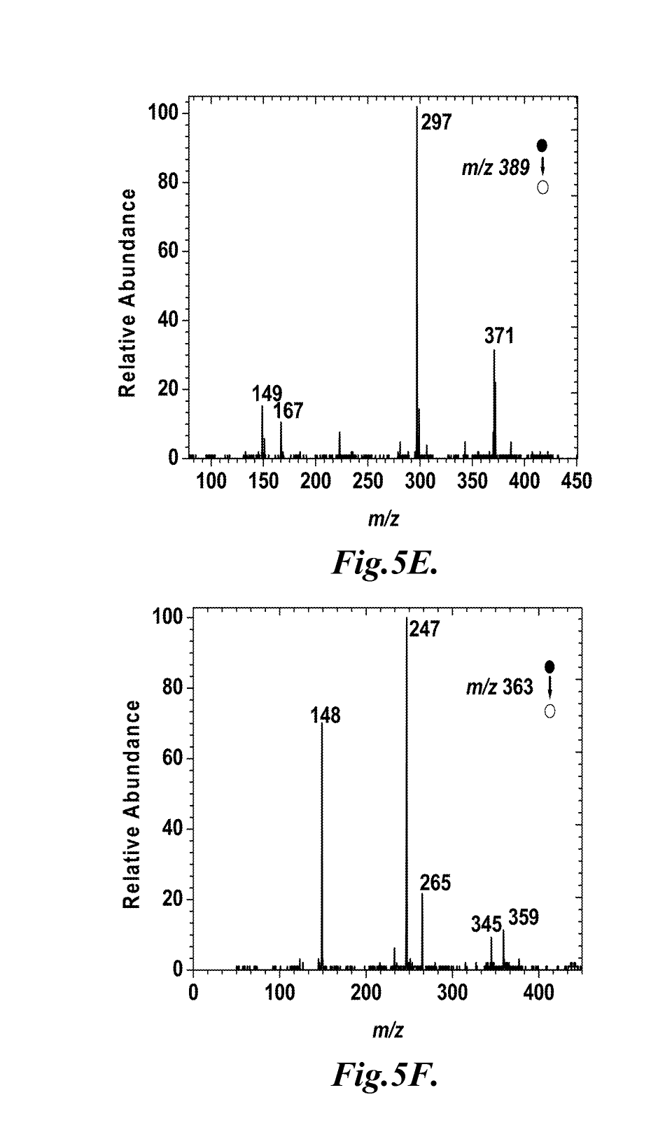

Following the ESI-MS results, the PPAMS coupled with the Bruker-Esquire LC-ion trap mass spectrometer was used to determine the capacity of the LTP-probe to ionize the nutrients. Pure powders of the individual nutrients were suspended on double stick tape and analyzed. Then, a solution of all five nutrients at HBLC was prepared in methanol, dried onto a glass surface, and analyzed. As shown in FIG. 5A, mass spectra were acquired from the control surfaces with a good signal to noise ratio. Several key fragments were observed for each of the nutrients. The peaks shown in FIG. 5A were first observed in the PPAMS (and MS/MS) spectra of the raw nutrient powders suspended on tape (data not shown). As an example, single PPAMS/MS spectra taken from each of the nutrient powders are presented in FIGS. 5B-5E. MS/MS spectra were collected for a number of fragments-of-interest for each of the nutrient powders. Representative spectra are shown in FIGS. 5A-5F.

As representative of the Zn powder PPAMS/MS, FIG. 5B shows the results for m/z 119 (ZnCl⁺+H₂+H₂O). The PPAMS/MS spectrum is characterized by the typical adducts m/z 64 (Zn⁺), m/z 99 (ZnCl⁺), and m/z 101 (ZnCl⁺+H₂). The peak at m/z 129 dominated the original Fe PPAMS spectrum (data not shown), and the resulting PPAMS/MS spectrum is shown in FIG. 5C. This peak was attributed to the Fe complex (CHNFe⁺+N₂+H₂O) based upon the presence of m/z 57 (FeH⁺), m/z 71 (FeNH⁺), m/z 83 (CHNFe⁺), and 111 (CHNFe⁺+N₂) in the MS/MS data.

In initial tests on neat Ret solutions and powders with both PPAMS and desorption electrospray ionization (DESI), Ret was observed to display significant fragmentation under the ambient conditions used. Subsequent tests determined that the fragmentation mechanism appeared to be primarily through pi-bond ozonolysis resulting in an aldehyde (or ketone)-terminated ion. This fragmentation has been observed to occur in unsaturated fatty acids and esters. The Ret molecule contains four locations where this cleavage can occur resulting in four fragments with corresponding m/z values of 153, 193, 219, and 259 referenced as fragments A, B, C, and D, respectively. The PPAMS/MS spectrum taken on the full Ret peak shown in FIG. 5D displays evidence of these four fragments through further potential fragmentations (water and/or ethylene loss) as well as epoxidation of the four starting fragments. The peaks present in the displayed spectrum are m/z 155 (Frag. A+H₂), m/z 199 (Frag. C+O−CH₂−OH), m/z 256 (Frag. D+O−H₂O), and m/z 271 (M⁺−H₂O).

Determination of the PPAMS/MS peak at 389 (shown in FIG. 5E) as a FA fragment was accomplished through the identification of the ion present at m/z 297 as the larger fragment produced by cleavage at the peptide bond or (C₁₂H₁₃N₂O₅+O₂). The peaks at m/z 167 and m/z 149 were assigned to the cleavage of the second peptide bond removing (C₅O₄H₇) and an additional water molecule, respectively. As representative of the Thyr powder PPAMS/MS, FIG. 5F shows m/z 363 consisting of one of the ring structures present in the full thyroxine molecule. The Thyr spectrum also showed expected fragments at m/z 345 (M₃₆₃⁺−H₂O), m/z 247 (M₃₆₃⁺+O−I−H₂O+CH) and m/z 232 (M₃₆₃⁺−H₂O−I+CH₂).

The efficacy of using PPAMS for ambient sampling of blood plasma with little or no sample preparation was demonstrated using a series of model solutions. Samples of the five micronutrients were prepared for PPAMS in a 10% porcine plasma solution prepared in isotonic citrate-phosphate buffered saline (cPBSz) containing sodium azide (0.01M sodium citrate, 0.01M sodium phosphate, 0.12 M sodium chloride, 0.02% (w/v) sodium azide, and was adjusted to a pH 7.4 with sodium hydroxide). The citrate was added for use both as a buffer and as a calcium chelator to inhibit the calcium-dependant proteases common to blood and blood products. The azide inhibits the growth of organisms that require oxidative phosphorylation to grow. Solutions were based on HBLCs and low blood level concentrations (LBLCs). HBLC samples were doped at 50 ppb FA, 625 ppb VitA, 105 ppb Thyr, 2 ppm Iron (prepared from FeCl₂ salt, Fe), and 20 ppm Zinc (prepared from ZnCl₂ salt, Zn). LBLC samples were doped at 5 ppb FA, 288 ppb Ret, 46 ppb Thyr, 0.5 ppm Fe, and 10 ppm Zn. Control samples included plain glass, plain 10% porcine plasma solution, all 5 nutrients at LBLC in 10% porcine plasma, and all 5 nutrients at HBLC in 10% porcine plasma.

Several different sample groups were tested, all in 10% porcine plasma solutions. The first test had samples doped with single nutrients at 10×HBLC, which was completed to determine peaks that may be indicative of specific nutrients. Next, samples were tested with a 1×HBLC for four nutrients, and 10× of the remaining single nutrient. The next experiment was completed to mimic a “relatively healthy” individual, with one nutrient at LBLC, and the other four at HBLC. Finally, a “relatively unhealthy” individual was tested, with one nutrient at HBLC and the other four at LBLC. 10 μl of each sample solution was deposited onto 12 mm clean glass cover slips, and placed in a dessicator overnight prior to analysis.

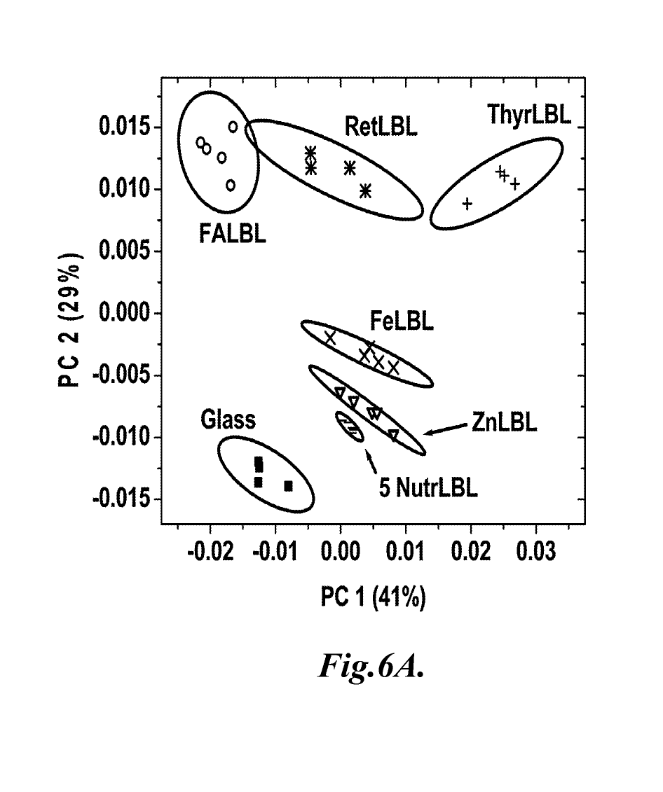

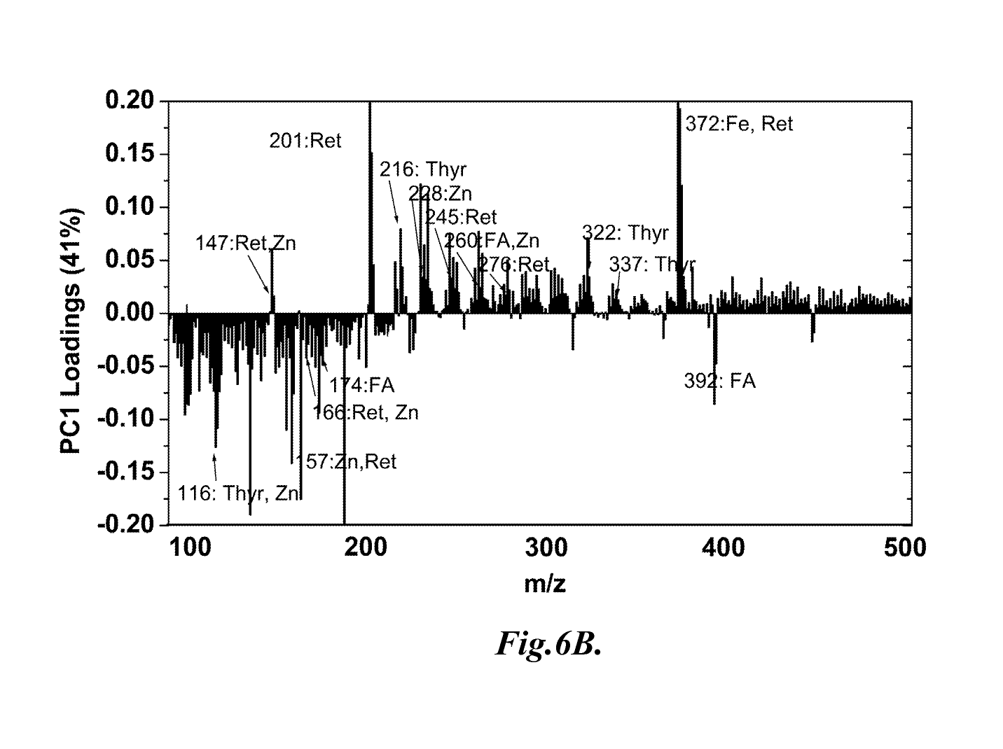

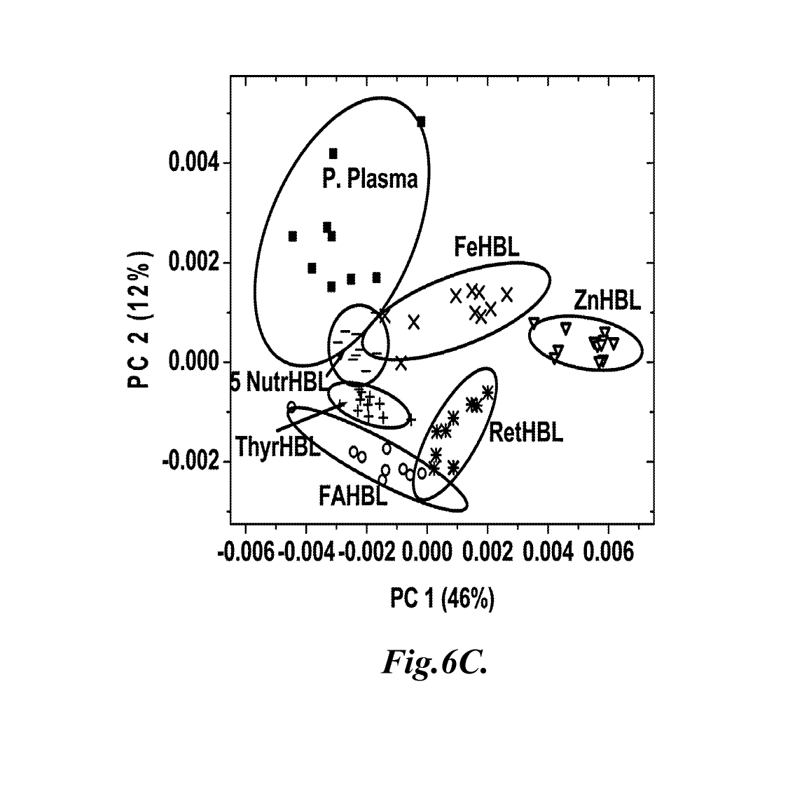

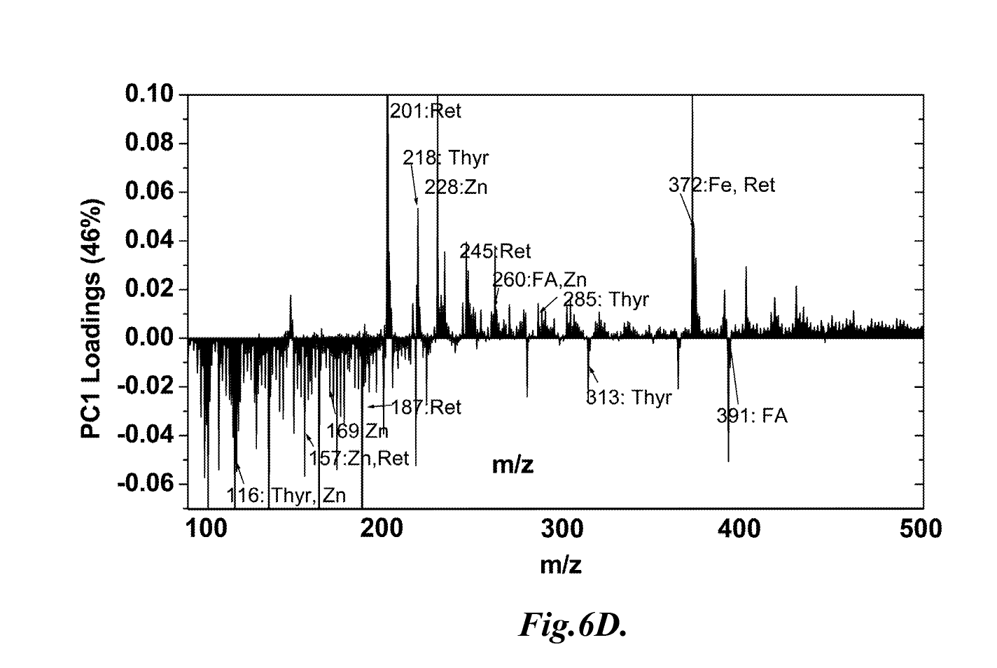

Using the LTP to ionize the samples and the ion trap MS for detection, the mass range of 50-1000 m/z was scanned in the positive mode. Unsupervised PCA was performed on the resulting spectra to determine if the nutrients could be separated at both the LBLCs and HBLCs from the complex solutions. As used herein, the term “unsupervised PCA” refers to PCA when all the peak fragments in a mass spectrum are chosen for PCA. Supervised PCA refers to PCA when the user creates a fragment list to focus the PCA. In the “relatively healthy” sample, with 4 nutrients at HBLC and 1 nutrient at LBLC, the data can be completely separated using the PC1 vs. PC2 sketch (FIG. 6A). In the “relatively unhealthy” sample, with 4 nutrients at LBLC and 1 nutrient at HBLC, the data is mostly separable to 95% confidence (FIG. 6C). While some of the 95% confidence ellipses do overlap, very few of the actual data points overlap. As expected, the scores did not yield a linear correlation between the abundance of the individual micronutrients with the addition of the buffer and protein solutions. However, the nutrients were separable at both high and low blood plasma concentrations and the PCA scores shifted based upon nutrient concentration. In addition, many of the peaks that were dominant in the loadings plot for the “healthy” plasma model were also present in the loadings plot for the “unhealthy” model (FIGS. 6B and 6D). Additional analysis was performed on this data by combining the relatively healthy and unhealthy data sets (data not shown). While the data did not completely separate using PC1 and PC2, the data grouped in anticipated manners. As expected, several of the samples with low nutrient concentrations contained significant overlap were observed. However, even the overlapping confidences ellipses were completely separated using additional PCs.

Analysis and detection of micronutrients is important for the reduction of the global burden of malnutrition-related disease. The present invention provides a system and method for the detection and quantitation of five key micronutrients. The analytical performance and ability to qualitatively separate micronutrients from a complex biological solution and each other was demonstrated through the application of PPAMS on a sample matrix of micronutrients in porcine plasma in which nutrient concentration is varied from high blood level concentrations (HBLCs) to low blood level concentrations (LBLCs). A multivariate software model, principal components analysis (PCA), was used to qualitatively separate the fragments obtained by nutrient type. The resulting PCA scores plots of the positive ion spectra from each mixed sample showed excellent separation of HBLCs and LBLCs of single nutrients at the 95% confidence level. The associated PCA loadings plots showed that key loadings could be attributed to the expected micronutrient fragments. The PPAMS technique was successfully demonstrated and compared with traditional MS techniques: time-of-flight secondary ion mass spectrometry (ToF-SIMS) and electrospray ionization mass spectrometry (ESI-MS). Separation of the nutrients at concentrations relevant for human blood-based nutrient detection was possible in both ESI-MS and PPAMS. However, only PPAMS was able to detect the nutrients at physiological concentrations from porcine plasma. ToF-SIMS detected the nutrients from plasma solution, but required 5× to 1000× higher concentrations of folate, vitamin A, and iodine to achieve adequate separation of the micronutrients via PCA.

PPAMS Analysis of Contaminants in Water

The following is a description of a representative method and system of the invention for the simultaneous in situ detection of multiple analytes (i.e., lead, copper, and zinc) in tap water. The experimental details are described in Example 2.

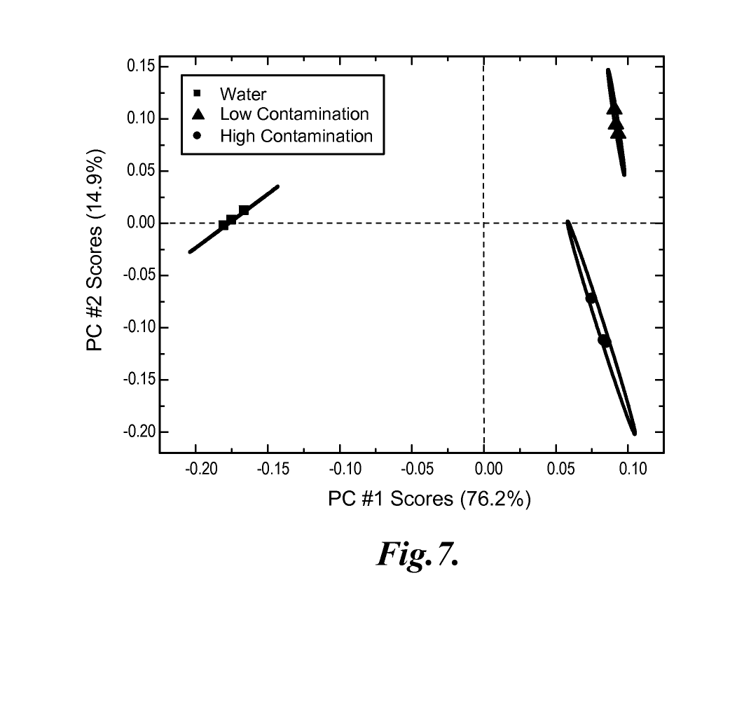

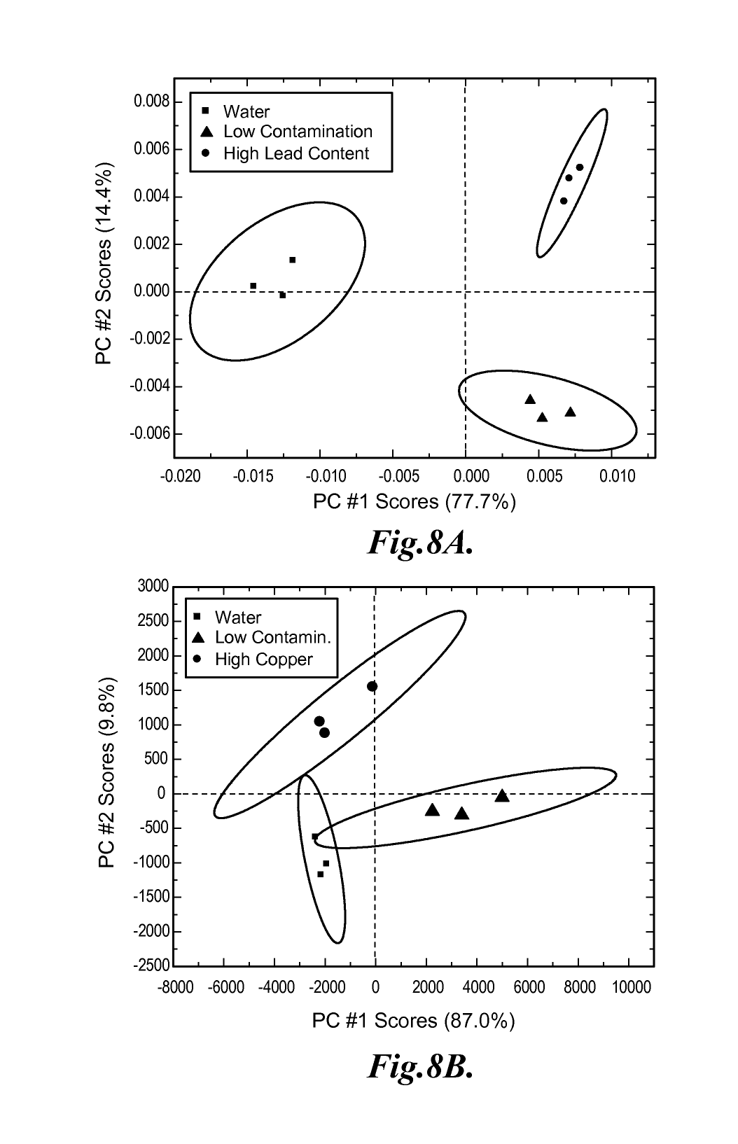

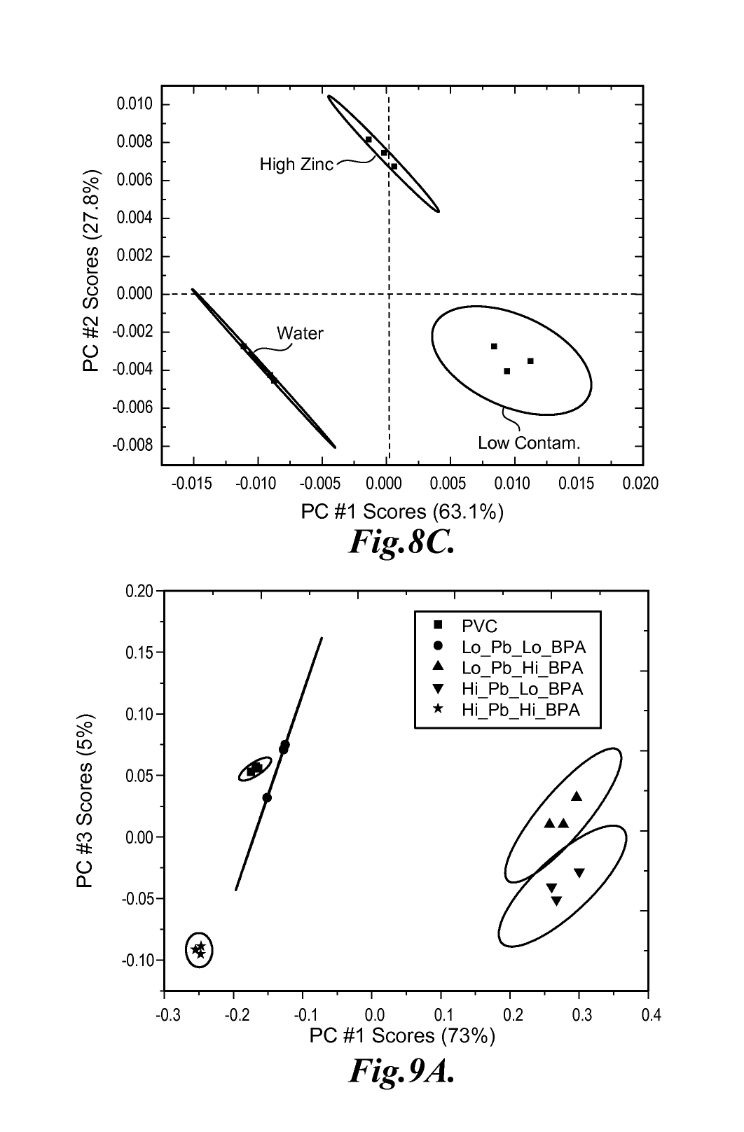

Raw mass spectra were obtained on doped water samples. Unsupervised PCA was then performed on the resulting spectra to separate the contaminants. Samples were first scaled to the total intensity of the spectrum, a square root transform was then applied to the entire spectra, and finally the data was mean centered. As shown in FIG. 7, the doped samples easily separated with 95% confidence from plain water at both low and high overall nutrient contamination values. Similarly, PCA was performed on plain water samples versus samples with all contaminants at low concentration and samples in which the concentration of a single contaminant was increased. The resulting plots are shown in FIGS. 8A-8C. A significant separation exists between water that was contaminant free and water that contained low-level contaminants and high-level contaminants, both individually and collectively.

PPAMS Analysis of Contaminants in Polyvinyl Chloride (PVC)

The following is a description of the use of a representative method and system of the invention for the simultaneous in situ detection and separation of multiple contaminants (i.e., lead and bisphenol A (BPA)) commonly found in plastics (i.e., polyvinyl chloride (PVC)). The experimental details are described in Example 3.

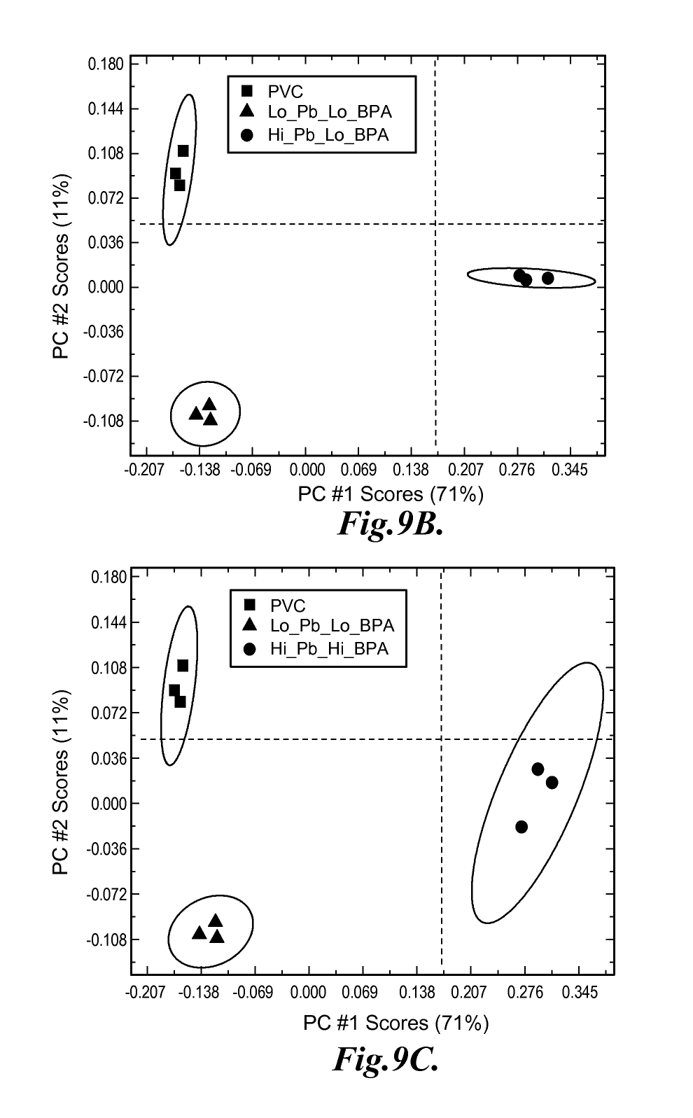

The method and system of the invention was used to analyze polymer products. Samples of PVC doped with known levels of contaminants, lead and BPA, were prepared. Utilizing spectra obtained from the system, unsupervised PCA was performed. As shown in FIG. 9A, samples containing pure PVC were compared against samples containing PVC in combination with either high or low lead and high or low BPA. These samples were shown to be separated using PC 1 and PC 3. To more clearly visualize sample differences, the data analysis was separated into multiple PCA plots. FIG. 9B illustrates the analysis of three components: the pure PVC sample, the low lead/low BPA sample, and the high lead/low BPA sample. Referring to FIG. 9B, PC 1 clearly separates pure PVC from the contaminated samples and PC 2 separates the safe level of lead from the high level of lead. FIG. 9C illustrates the analysis of three other components: the PVC sample, the low lead/low BPA sample, and the low lead/high BPA sample. Referring to FIG. 9C, the contaminants are mostly separated from pure PVC in PC 1, and the low and high levels of BPA are separated in PC 2.

The following examples are provided for the purpose of illustrating, not limiting, the invention.

### EXAMPLES

### Example 1

### Representative PPAMS Method

### Nutrient Powder

In this example, the materials, methods for carrying of a representative method of the invention (a method for analyzing a powder comprising multiple nutrients), and comparative mass spectrometric methods are described.

Chemicals and Reagents.

The analyzed nutrients, folic acid (FA, C₁₉H₁₉N₇O₆), retinol (Ret, C₂₀H₃₀O, analog of vitamin A), thyroxine (Thyr, iodine bound to a physiologic carrier, C₁₅H₁₁I₄NO₄), iron (Fe, prepared from FeCl₂ salt), and zinc (Zn, prepared from ZnCl₂ salt) were acquired as dry crystalline powders from Sigma-Aldrich Chemical Co. (St. Louis, Mich.) and used as received. For folic acid and retinol, which are not water soluble, stock solutions were prepared by dissolving the powders in dimethylsulfoxide (DMSO, Sigma-Aldrich, Milwaukee, Wis.) and ethanol (EtOH, Mallinckrodt Baker Inc., Phillipsburg, N.J.), respectively. The final concentrations were 0.5 mg/mL FA/DMSO, and 0.65 mg/mL Ret/EtOH. The nutrients were then further diluted to their desired concentrations with aqueous solvents. Deionized/distilled water (dH₂O) was obtained from a Barnstead/Thermolyne deionizer unit (Nanopure, 18MΩ·cm resistivity, Dubaque, Iowa). Bovine serum albumin (BSA, A-7638, Sigma, St. Louis, Mo.) was purchased and used as an initial analog for blood. Porcine plasma (PL26009, Innovative Research, Novi, Mi) was used as the blood model for PPAMS testing.

Time-of-Flight Secondary Ion Mass Spectrometry (ToF-SIMS). ToF-SIMS spectra were obtained with a TOF-SIMS 5-100 time-of-flight spectrometer (ION-TOF, Münster, Germany). Samples were analyzed using a 25 keV Bi₃⁺ primary ion source under static conditions (primary ion dose <10¹² ions/cm²) and were charge neutralized using an electron flood gun. Six positive and three negative secondary ion spectra were collected from each sample using 100×100 μm² analysis areas over a mass range of m/z=1-878. Duplicate samples were analyzed yielding 12 positive and 6 negative secondary ion spectra per sample type. Positive ion spectra were mass calibrated using CH₃⁺, C₂H₃⁺, C₃H₅⁺ and C₇H₇⁺ peaks, and negative ion spectra were mass calibrated using CH⁻, OH⁻ and C₂H⁻ peaks before further analysis. As positive spectra produced the strongest data trends, only positive ion ToF-SIMS data are described herein. The resulting spectra were analyzed with the Surface Lab 6 software package from ION-TOF. Peak lists were constructed starting with a base of protein-related peaks adapted from Brown, B. N.; Barnes, C. A.; Kasick, R. T.; Michel, R.; Gilbert, T. W.; Beer-Stolz, D.; Castner, D. G.; Ratner, B. D.; Badylak, S. F. Biomaterials 2010, 31, 428-437, expressly incorporated herein by reference in its entirety, and were supplemented with nutrient-related peaks. Nutrient-related peaks were verified by the presence of the peak in the nutrient sample and absence of the peak in the control sample or a peak whose intensity was proportional to nutrient concentration.

Electrospray Ionization Mass Spectroscopy (ESI-MS).

To verify that the mass spectrometer to be utilized in the PPAMS experiments could measure the micronutrients in a physiologically relevant range, ESI-MS was performed. Positive ion electrospray MS and MS/MS spectra were obtained on a Bruker-Esquire LC-ion trap mass spectrometer (Bruker/Hewlett-Packard, Billerica, Mass.). Samples were infused by flow injection at 1.5 μL/min via a syringe pump (Cole Parmer model 74900) and ionized in a standard orthogonal Bruker ionizer. The mass spectrometer settings were as follows: electrospray capillary, 100 V; transfer capillary, 70 V; drying gas temperature, 250° C.; skimmer 1, 20 V; skimmer 2, 6.0 V; octopole I, 3 V; octopole II, 1 V; octopole radiofrequency, 100 V; peak-to-peak lens I voltage, −5 V; lens II voltage, −60 V. Mass spectra were obtained by ejecting trapped ions in the range of m/z 50-1100 for all samples. Approximately 100 scans were accumulated and averaged to provide the spectra used for quantification. Mass assignments were determined from spectra using Bruker data analysis software.

Plasma Pencil Atmospheric Mass Spectrometry (PPAMS).

Experiments were performed on a Bruker-Esquire LC-ion trap mass spectrometer (Billerica, Mass.). As with the ESI-MS, data was acquired and analyzed with the associated Bruker software. PPAMS was performed in the positive and negative-ion mode on pure micronutrient stock powders. As positive mode yielded the best data, only positive ion PPAMS data are presented herein. The primary experimental parameters used were: m/z range 50-1100; peak-to-peak lens I voltage, −5 V; lens II voltage, −60 V; skimmer 1, 15 V; skimmer 2, 4.0 V, octopole I, 3 V; octopole II, 2 V. The spectrometer was programmed to collect spectra for a maximum ion trap injection time of 200 ms with 2 microscans per spectrum. The scans were averaged over 30 seconds of acquisition time.

A low-temperature plasma probe (LTP-probe) was constructed as described below for the generation of an atmospheric plasma at low temperatures (about 30° C.). This instrument enables the analysis of samples without visibly noticeable sample decomposition or destruction. The LTP-probe consists of a glass tube (o.d. 6.35 mm, i.d. 3.75 mm) with an internal grounded electrode (stainless-steel; diameter 1.33 mm) centered axially and an outer electrode of copper tape surrounding the tube's exterior. The wall of the glass tube serves as the dielectric barrier. The plasma plume was created by applying an alternating high voltage of 3-6 kV at a varying frequency of 2-5 kHz to the outer electrode, leaving the inner electrode grounded to generate the dielectric barrier discharge. The discharge AC voltage was provided by a custom built power supply utilizing a square-type waveform with adjustable frequency and amplitude. The total power consumption was below 3 W. Helium discharge gas was fed through the tube's interior region to facilitate the discharge and to transport the analyte ions into the mass spectrometer's inlet. Samples were placed on a sample holder 1-2 cm away from the mass spectrometer inlet, and 3-5 mm away from the plasma source. The plasma source was placed at an angle of about 60° from the sample surface.

Principal Component Analysis (PCA).

A multivariate analysis technique, principal component analysis (PCA), which captures the linear combination of peaks that describe the primary sources of variance in a given dataset (known as principal components, PCs) was employed to analyze the resulting spectral data using a Matlab (The MathWorks, Inc., Natick, Mass.) program. For ToF-SIMS data, initially, a complete peak set was created for data analysis that included all peaks whose intensities were >100 counts for m/z<100, >50 counts for m/z between 100-200, and >5 counts for m/z>200. Then, to further analyze the data, the peak list was reduced to include only the protein and nutrient peaks as described in the ToF-SIMS section. For all other data, depending on the experimental protocol, either the entire spectra or chosen peak sets were normalized to the sum of the selected peaks to account for fluctuations in yield between spectra, while attempting to reduce the influence of background noise on the analysis. PCA was performed using the NESAC/BIO MVA Toolbox (Seattle, Wash.) for MATLAB (the MathWorks, Inc., Natick, Mass.). All spectra were mean-centered before running PCA.

### Example 2

### Representative PPAMS Method

### Contaminated Water

In this example, a representative method of the invention, a method for analyzing a contaminated water sample, is described. Tap water was treated with lead, copper, and zinc and was analyzed by the method.

Chemicals and Reagents.

Lead acetate trihydrate (MW: 379.33), copper (I) chloride (MW: 99), and zinc chloride (MW: 136.30) were acquired as dry crystalline powders from Sigma-Aldrich Chemical Co. (St. Louis, Mich.) and were used as common tap water contaminants. Copper chloride was prepared in a 1M HCl solution, while lead and zinc stock solutions were directly dissolved in deionized distilled water (dH₂O) obtained from a Barnstead/Thermolyne deionizer unit (Nanopure, 18 MΩ·cm resistivity, Dubaque, Iowa). These components (contaminants) were initially prepared at 100× concentration, prior to dilution. Water concentrations of 15 ppb lead, 1.3 ppm copper, and 5 ppm zinc were utilized as the final “low contamination” tap water values. Similarly, 75 ppb lead, 6.5 ppm copper, and 25 ppm zinc were used for “medium contamination” tap water levels, and 150 ppb lead, 13 ppm copper, and 50 ppm zinc were used for “high contamination” tap water values. Concentrations were selected such that the low level samples would pass water safety inspections, while the medium and high levels would not.

Plasma Pencil Atmospheric Mass Spectrometry (PPAMS).

Experiments were performed on a Bruker-Esquire LC-ion trap mass spectrometer (Billerica, Mass.). All data was acquired with the associated Bruker data analysis software, in the positive-ion mode. The primary experimental parameters used were: m/z range 50-1100; peak-to-peak lens I voltage, −5 V; lens II voltage, −60 V; skimmer 1, 15 V; skimmer 2, 4.0 V, octopole I, 3 V; octopole II, 2 V. The spectrometer was programmed to collect spectra for a maximum ion trap injection time of 200 ms with 2 microscans per spectrum. The scans were averaged over 30 seconds of acquisition time.

The low-temperature plasma probe (LTP-probe) used was as described above in Example 1. The water contamination samples consisted of approximately 1 mL of sample liquid pipetted into a clean plastic petri dish with the liquid interface approximately 1-2 cm away from the mass spectrometer (MS) inlet, and 3-5 mm away from the plasma source. The plasma source was placed at an angle of about 60° from the sample surface.

Principal component analysis was used as described above in Example 1.

### Example 3

### Representative PPAMS Method

### Contaminated Plastic

In this example, a representative method of the invention, a method for analyzing a contaminated plastic material, is described. Polyvinyl chloride (PVC) was treated with lead and bisphenol A and was analyzed by the method.

To mimic contaminants found in plastics, such as in toys or food films, polyvinyl chloride (PVC, Scientific Polymer Products, Ontario, N.Y., MW: 215 000) was used as a base to which bisphenol A (BPA, Sigma Aldrich, MW: 228.29) and lead acetate trihydrate were added. PVC was dissolved in dichloromethane (DCM) at a concentration of 1 mg/ml by stirring the solution at 600 rpm for 2 days. 90 ppm lead and 75 ppm BPA were utilized for “low concentration” toy values, while 600 ppm lead and 500 ppm BPA were used as “high concentration” toy values. All contaminants were added in reference to the total amount of PVC present in solution. A 20 μl droplet of the final PVC solutions was pipetted onto a 12 mm diameter clean glass slide. These samples dried within 2 minutes. The slides were maintained still overnight in a vacuum desiccator prior to analysis.

Plasma pencil atmospheric mass spectrometry (PPAMS) analysis was as described above in Example 2. Principal component analysis was used as described above in Example 2.

While illustrative embodiments have been illustrated and described, it will be appreciated that various changes can be made therein without departing from the spirit and scope of the invention.

1. A method for detecting analytes in a sample material, comprising:
(a) generating analyte particles by ambient desorptive ionization of a sample material;
(b) analyzing the analyte particles with a mass analyzer to provide a mass spectrum of the analyte particles from a mixed sample; and
(c) determining the presence of the analytes in the sample material by multivariate statistical analysis of the mass spectrum.

2. The method of claim 1, wherein generating analyte particles by ambient desorption ionization comprises contacting the sample material with a plasma.

3. The method of claim 2, wherein the plasma is a low temperature plasma.

4. The method of claim 1, wherein generating analyte particles by ambient desorption ionization comprises contacting the sample material with a desorption electrospray ionization source, a paper spray ionization source, a desorption sonic spray ionization source, a desorption atmospheric pressure photoionization source, a direct analysis in real time source, an atmospheric solids analysis probe source, a desorption atmospheric pressure chemical ionization source, a dielectric barrier discharge ionization source, a plasma-assisted desorption/ionization source, a neutral desorption sampling extractive electrospray ionization source, an electrospray-assisted laser desorption ionization source, a laser ablation-electrospray ionization source, a matrix-assisted laser desorption electrospray ionization source, or an infrared laser-assisted desorption electrospray ionization source.

5. The method of claim 1, wherein the analyte particle is a positive ion.

6. The method of claim 1, wherein the analyte particle is a negative ion.

7. The method of claim 1, wherein the mass analyzer is an atmospheric mass analyzer.

8. The method of claim 1, wherein the mass analyzer is a mass spectrometer.

9. The method of claim 1, wherein the mass analyzer is an ion mobility spectrometer.

10. The method of claim 1, wherein the mass analyzer is an ion trap mass spectrometer, a quadrupole mass spectrometer, or an ion cyclotron mass spectrometer.

11. The method of claim 1, wherein the multivariate statistical analysis comprises principal components analysis.

12. The method of claim 1, wherein the multivariate statistical analysis comprises partial least-squares regression analysis.

13. The method of claim 1, wherein the sample material is a solid.

14. The method of claim 1, wherein the sample material is a liquid.

15. The method of claim 1, wherein the sample material is surface coating.

16. The method of claim 1, wherein the sample material is a plastic, a polymer, a fabric, a textile, a metal, a ceramic, or mixtures thereof.

17. The method of claim 1, wherein the sample material is aqueous.

18. The method of claim 1, wherein the sample material is whole blood, blood plasma, saliva, mucus, urine, skin, hair, tissue, or mixtures thereof.

19. The method of claim 1, wherein the sample material is a food or drink.

20. The method of claim 1, wherein the sample material is a chemical agent.

21. The method of claim 1, wherein the sample material is a pharmaceutical agent.

22. The method of claim 1, wherein the sample material is an explosive.

23. A system for detecting analytes in a sample material, comprising:
(a) an ambient desorptive ionization source for generating analyte particles;
(b) a mass analyzer for analyzing the analyte particles to provide a mass spectrum of the particles; and
(c) a multivariate statistical analysis program for analyzing the mass spectrum to determine the presence of the analytes in the sample material.

24. The system of claim 23, wherein the ambient desorption ionization source is a plasma.

25. The system of claim 23, wherein the ambient desorption ionization source is a low temperature plasma.

26. The system of claim 23, wherein the ambient desorptive ionization source is a desorption electrospray ionization source, a paper spray ionization source, a desorption sonic spray ionization source, a desorption atmospheric pressure photoionization source, a direct analysis in real time source, an atmospheric solids analysis probe source, a desorption atmospheric pressure chemical ionization source, a dielectric barrier discharge ionization source, a plasma-assisted desorption/ionization source, a low temperature plasma source, a neutral desorption sampling extractive electrospray ionization source, an electrospray-assisted laser desorption ionization source, a laser ablation-electrospray ionization source, a matrix-assisted laser desorption electrospray ionization source, or a infrared laser-assisted desorption electrospray ionization source.

27. The system of claim 23, wherein the mass analyzer is an atmospheric mass analyzer.

28. The system of claim 23, wherein the mass analyzer is a mass spectrometer.

29. The system of claim 23, wherein the mass analyzer is an ion mobility spectrometer.

30. The system of claim 23, wherein the mass analyzer is an ion trap mass spectrometer, a quadrupole mass spectrometer, or an ion cyclotron mass spectrometer.

31. The system of claim 23, wherein the multivariate statistical analysis program comprises a principal components analysis program.

32. The system of claim 23, wherein the multivariate statistical analysis program comprises partial least-squares regression analysis program.
